(19) United States
(12) Patent Application Publication
(10) Pub. No.: US 2009/0046710 A1
(43) Pub. Date: Feb. 19, 2009

(54) Method and Device for Transmitting Signalling Data Between Peripheral Appliances of a Switching System

(75) Inventors: Jonas Hof, Munchen (DE); Norbert Lobig, Darmstadt (DE); Jurgen Tegeler, Penzberg (DE); Michael Tinnacher, Koflach (AT); Dieter Wallner, Graz (AT)

Correspondence Address: BELL, BOYD & LLOYD, LLP, P.O. BOX 1135, CHICAGO, IL, 60690, US

(73) Assignee: Nokia Siemens Networks GmbH & Co KG, Munich (DE)

(21) Appl. No.: 11/884,285

(22) PCT Filed: Sep. 12, 2005
(86) PCT No.: PCT/EP05/54515

§ 371 Date: Jun. 6, 2008

(30) Foreign Application Priority Data
Feb. 16, 2005 (DE) 10 2005 007 062.0

(51) Int. Cl. H04L 12/56

(52) U.S. Cl. 370/389

(57) ABSTRACT

A cost-effective transmission of signaling data via a switching system comprising a first mostly highly reliable message distribution system, using at least one other message distribution system is provided. The signaling data is divided in the emitting peripheral appliance, into a data relevant to the switching system and data not relevant to the switching system. Relevant data is transmitted via the first message distribution system, and non relevant data which is transmitted via the at least one other message distribution system. Both parts can be joined together again in the receiving peripheral device to form the original signaling data. Furthermore, a stand-alone error detection process for the at least one other message distribution system runs in the peripheral appliances, giving rise to a deviation of the non relevant data via the original message distribution system, in the event of error, or the use of a functional, redundant peripheral device.

The invention relates to a method for transmitting signaling data between peripheral appliances of a switching system.

Conventional switching systems in telecommunication networks consist of peripheral appliances, a central control device, a switching network (if the user data is routed via the switching center), a message distribution system as well as further appliances for the operation and protocol handling. The message distribution system is, in this case, generally of dual configuration and highly reliable, as it transports internal control data and/or control messages of the switching system between the peripheral and the central appliances of the switching system. Said control messages are generally information for upstream or downstream switching nodes or subscriber-side appliances and subscriber terminals. The control messages are transmitted between the peripheral appliances via at least one so-called signaling channel of the message distribution system of the switching system.

Highly reliable message distribution systems according to the prior art are dimensioned according to the needs and requirements of the connection and disconnection of signaling connections as well as the messages to be additionally transmitted when a connection is made. Said additional messages are, for example, required for the handling of switching facilities such as CF (“call forwarding”), CT (“call transfer”), conferencing, or the like. The size of the message distribution system of a switching system is thus substantially dependent on the amount and the type of lines to be operated and subscribers and is determined by the traffic pattern (for example the level of use of switching facilities).

Due to the fact that in modern telecommunication networks the intelligence of the services provided, however, is to an increasing extent shifted from the switching centers into the subscriber-side peripherals or the subscriber terminals, the data throughput required for the connection build-up and the transmission of the characteristic properties of the terminals involved, continually increases. Examples of such particular features of the terminals are, namely, the coding methods for audio and video supported by the respective terminals. Within the scope of H.248 and SIP protocol (“session initiation protocol”), for example so-called SDP data (“session description protocol” data) are exchanged, therefore, via the signaling channel, which allow the terminals to combine the coding methods to be used for a connection. A further example in which increased data throughput occurs, is the transmission of data packets on the D-channel of an ISDN connection. Even in this case, additional information about the signaling channels of the message distribution system has to be transmitted.

Two essential types of signaling data may, therefore, be distinguished: conventional data relevant to the switching system, which to a large extent carries relevant information for connecting and disconnecting connections, as well as data not relevant to the switching system, which contains multiple information about the terminals associated with the respective users.

As a result of this increased data throughput, however, a series of problems results both for conventional, TDM (“time division multiplexing”) based switching centers and for more up-to-date switching centers in packet-oriented communication networks. Thus the highly reliable message system is particularly sensitive with regard to the additional data determined by the terminal and/or the end user. High peak loads within the system may also lead to a delay in the transmission of further control messages, as does increased throughput of longer messages, which may impair the performance quality to be ensured by the switching center. In particular, the delay of information relevant to the connection is only permissible within very narrow limits, in conventional telecommunications, due to the very strict requirements in this case. Increased data throughput in conventional systems may possibly even lead to a loss of data.

In the method according to the prior art, the aforementioned problem is countered by increasing the size of the switching system, in particular the message distribution system. As a result, however, firstly the complexity of the system naturally increases, and secondly the switching system has to be of sufficiently large size for all possible cases, in order to be able to ensure a secure operation at the required quality which in most cases, therefore, in fact leads to the switching system being oversized.

If the message distribution system, as regards subscriber peripherals and connection line peripherals, however, is not able to be adequately disconnected, the switching system generally remains underused and is therefore suboptimal with regard to the costs per connection.

Additionally, the loading on the switching system has to be continually monitored via traffic measurement means, due to the presence of signaling data which varies over time. For the operator of the switching system this results in a further increase in costs per connection.

The object of the invention is to transport signaling data reliably and cost-effectively from the point of view of the manufacturer and operator by means of a switching system, without impairing switching reaction times and services.

The object is achieved proceeding from a method according to the features of the preamble of claim 1 by the characterizing features thereof. Advantageous embodiments of the invention are provided in the sub-claims.

The invention relates to the transmission of signaling data between the peripheral appliances of a switching system, which comprises a first message distribution system and at least one further message distribution system. The essential aspect of the method according to the invention is that the signaling data in the emitting peripheral appliance is divided into data relevant to the switching system and data not relevant to the switching system. Whilst the part of the signaling data relevant to the switching system is transmitted via the first message distribution system, the part of the signaling data not relevant to the switching system may be transmitted via the first message distribution system or via the at least one further message distribution system. Both parts are joined together again in the receiving peripheral appliance to form the signaling data.

The at least one further message distribution system may advantageously be a cost-effective message distribution system which does not necessarily provide all functions of the first message distribution system.

Thus, advantageously, the at least one further message distribution system may not necessarily support all the intercommunication relations between the individual peripheral appliances which are supported by the first message distribution system. In other words, it is not necessary, for example, for all peripheral appliances connected to the first message distribution system to be also connected to the at least one further message distribution system, and/or that communication between all peripheral appliances is possible via the at least one further message distribution system.

Moreover, in addition, all strict requirements for a message distribution system of a switching center do not necessarily have to be fulfilled, for example with regard to availability, message loss, redundancy, propagation times.

A further advantage of the method according to the invention is providing a function monitoring system for the at least one further message distribution system. In this connection, it is ensured that the communication inside the at least one further message distribution system is monitored and errors which occur are determined at the same time.

If errors are identified during the data transmission by the function monitoring system, a localization of the error is advantageously carried out. This function monitoring system substantially uses the functions of the highly reliable first message distribution system for error localization.

Should it be determined, therefore, that the error has occurred in a peripheral appliance, according to a further advantage of the invention the procedures of a switching center which are usual for such a case are carried out.

Should the error, however, not occur in one of the peripheral appliances, according to the invention the error is further localized by directly accessing the appliances detecting the error. The data to be transmitted via the relevant communication paths of the at least one further message distribution system, if possible, is advantageously routed via the first message distribution system, as an alternative, for the duration of the disruption.

A further advantage of the method according to the invention, is the alerting of faulty components, after the error has been localized. This alerting may advantageously be carried out by a central alarm device. In this case, it is avoided that a single error is identified by a plurality of peripheral appliances and the alert is repeatedly triggered. The central alarm device may additionally be accommodated advantageously in one of the peripheral appliances.

A failed communication path of the additional message distribution system is monitored for re-availability by the peripheral appliances terminating said communication path or using said communication path. This has the advantage that the re-availability is rapidly and easily identified without complex operations and dependencies on the structures and functions of the switching system.

With the method it has to be ensured that the requirements generally set for a switching center are unrestrictedly fulfilled both in normal error-free operation and also in faulty operation. In particular, this applies to the alerting, the switching reaction times as well as the processes during repair and restarting.

The invention is now described hereinafter in more detail with reference to the accompanying drawings, in which:

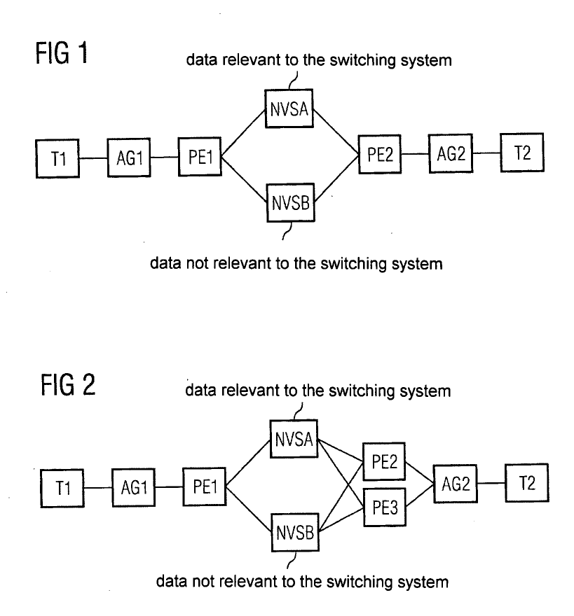

FIG. 1 shows a first exemplary embodiment of a message distribution system according to the inventive method, and

FIG. 2 shows a second exemplary embodiment of a message distribution system according to the inventive method.

FIG. 1 shows an embodiment of the method for transmitting signaling data according to the invention. In this embodiment, for reasons of clarity, only two subscribers T1 and T2 are connected to the telecommunication network.

The subscriber data of subscriber T1 (signaling data consisting of data relevant to the switching system and data not relevant to the switching system, i.e. for example user-relevant data) is forwarded from a first access gateway AG1 to a first peripheral appliance PE1. Said peripheral appliance PE1 is connected both to a first message distribution system NVSA and to a second message distribution system NVSB of the switching system. These two message distribution systems NVSA and NVSB are, moreover, connected to a second peripheral appliance PE2. The peripheral appliance PE2 is, in turn, connected to a second access gateway AG2 connected to the second subscriber T2.

In error-free operation, the data sent by the subscriber T1 is forwarded from the access gateway AG1 to the peripheral appliance PE1. The peripheral appliance PE1 subsequently divides the received signaling data into data relevant to the switching system and data not relevant to the switching system.

The part of the signaling data relevant to the switching system is, therefore, transmitted by the peripheral appliance PE1 via the first message distribution system NVSA to the peripheral appliance PE2. Said data transmission is optionally carried out indirectly via further intermediate devices of the switching system and is not necessarily transparent with regard to the partially used protocol and information contained in the messages.

The first message distribution system NVSA is, in this case, a highly reliable message distribution system associated with the prior art of a conventional switching system.

Additional data not relevant to the switching system which is possibly present is, in this exemplary embodiment, transmitted from the peripheral appliance PE1 via the second further message distribution system NVSB to the peripheral appliance PE2. This additional message distribution system NVSB may, for example, be a more cost-effective message distribution system which does not include all the functions of the first message distribution system NVSA and which also does not necessarily achieve the reliability and availability of the highly reliable message distribution system NVSA. For example, a pre-existing LAN “local area network” connection associated with the prior art may be used as the message distribution system NVSB between the peripheral appliance PE1 and the peripheral appliance PE2.

The receiving peripheral appliance PE2, provided this is necessary, finally joins both parts together again (i.e. the data relevant to the switching system which has been transmitted via the message distribution system NVSA, processed by the switching center and possibly altered by the switching center, as well as the data not relevant to the switching system, which has been transmitted transparently via the message distribution system NVSB). In this case, the sequence required by the respective signaling standard is adhered to, i.e. the data are joined together according to the signaling definition and the functions to be achieved.

Subsequently, the signaling data obtained in this manner is forwarded from the peripheral appliance PE2 to access gateway AG2. Access gateway AG2 finally transmits the data to the subscriber TN2.

A function monitoring system of the further message distribution system NVSB additionally operates on all peripheral appliances PE1 and PE2. This makes it possible to determine faulty communication within the second message distribution system NVSB at the same time and to trigger specific switching reactions. If, therefore, an error results between the peripheral appliance PE1 and PE2 in the transmission of the data not relevant to the switching system, i.e. the peripheral appliance PE1 is not able to reach peripheral appliance PE2 via NVSB (PE2 is not available on this path), this is automatically determined by the aforementioned function monitoring system.

In this case, an automatic error localization process starts. To carry out said error localization, procedures are substantially undertaken which use the existence of the first message distribution system NVSA (of the highly available message system).

If, for example, a peripheral appliance (in this case PE2) necessary for a connection is no longer able to be reached via the second message distribution system NVSB, the reason for this is either in the temporary non-availability of the peripheral appliance PE2 itself (for example due to equipment failure, restart or configuration) or in an error on the communication path to said peripheral appliance PE2.

A first localization of the error, namely the monitoring of the fact whether the accessed peripheral appliance PE2 has itself failed, is carried out by a direct communication of the peripheral appliance PE1 detecting the error with the accessed peripheral appliance PE2 via the highly available message distribution system NVSA. If the peripheral appliance PE2 is also not able to be reached via said message distribution system NVSA, the error is located directly in the peripheral appliance PE2.

In this case, without further procedures, the mechanisms of the switching center which are conventional according to the prior art for such a case come into effect: the highly reliable maintenance sequences of the switching center are carried out and ensure, amongst others, accurate alerting, triggering of relevant connections, release of associated in-system resources as well as support of interference suppression and/or repairs and rapid re-start. From the point of view of the method according to the invention, only the rejection of the transmission of signaling data not relevant to the switching system, which is possibly also desired, as well as continuous monitoring of the communication paths of the second message distribution system NVSB are carried out in order to be able to determine further availability of the peripheral appliance PE2 via the second message distribution system NVSB.

If it is determined during the error localization that the error is not located in the peripheral appliance PE2, i.e. if the peripheral appliance PE2 may also be reached via the message distribution system NVSA, the error is located in the interfaces or in the intermediate components of the second message distribution system NVSB.

In this case, according to the inventive method, the alternative diversion of data not relevant to the switching system to be transmitted, via the first highly reliable message distribution system NVSA, the rejection of said data or the disconnection of the connection are considered as a switching reaction.

Moreover, according to the invention a separate alerting of the relevant component is provided. To this end, a specific monitoring of the availability of the corresponding interfaces and the intermediate components is carried out.

In order to avoid repeated alerting by different peripheral appliances due to a single error, the alerting may preferably be carried out by a central alarm device, which represents the alarm interface for errors of the second, additional message distribution system NVSB in the direction of the operator. In addition, said alarm device may advantageously be accommodated in one of the peripheral appliances PE1 or PE2.

FIG. 2 shows, therefore, by way of example, an embodiment of the method according to the invention when an error occurs on the communication path between the peripheral appliance PE1 and the peripheral appliance PE2, and a further peripheral appliance PE3 of the switching center exists which is redundant in its function relative to the peripheral appliance PE2. In other words, therefore, PE3 may undertake all tasks of the peripheral appliance PE2.

The peripheral appliance PE3, as shown in FIG. 2, in a similar manner to the peripheral appliance PE2 is connected to access gateway AG2 as well as to the two message distribution systems NVSA and NVSB. In such a construction, the method according to the invention is functionally extended such that in addition to monitoring the communication path to the accessed peripheral appliance PE2, at the same time the alternative path to the redundant peripheral appliance PE3 is also monitored.

In such a case, should an error occur in the communication and should it be determined by the error localization that the error is directly located in the originally accessed peripheral appliance PE2, the communication according to the inventive method is diverted via a still active communication path (possibly via the first, highly reliable message distribution system NVSA) to the redundant peripheral appliance PE3. The peripheral appliance PE3 thus undertakes the functions of the originally addressed peripheral appliance PE2 of the switching center.

Should a plurality of peripheral appliances exist, which respectively are able to take on tasks of other peripheral appliances, the method according to the invention may naturally be accordingly extended.

1.-15. (canceled)

16. A method for transmitting signaling data between peripheral appliances of a switching system, which comprises a first message distribution system and a second message distribution system, comprising:
dividing the signaling data in a first peripheral appliance into a part relevant to the switching system and a part not relevant to the switching system;
transmitting the relevant via the first message distribution system to a receiving peripheral appliance;
transmitting the non relevant part via the first message distribution system or via the second message distribution system to the receiving peripheral appliance; and
joining the relevant and non relevant parts in the receiving peripheral appliance receiving peripheral appliance.

17. A method for transmitting signaling data between peripheral appliances of a switching system, which comprises a first message distribution system and a second message distribution system, comprising:
dividing the signaling data in a first peripheral appliance into a part relevant to the switching system and a part not relevant to the switching system;
transmitting the relevant via the first message distribution system to a receiving peripheral appliance;
transmitting the non relevant part via the second message distribution system to the receiving peripheral appliance; and
joining the relevant and non relevant parts in the receiving peripheral appliance receiving peripheral appliance to form a joined signaling data.

18. The method as claimed in claim 17, wherein the first message distribution system provides a plurality of functions and the first message distribution provides a portion of the plurality of functions.

19. The method as claimed in claim 17, wherein the first message distribution system supports a plurality of intercommunication relations between peripheral appliances and the first message distribution provides a portion of the plurality of intercommunication relations.

20. The method as claimed in claim 17, wherein the second message distribution system has a lower reliability or availability than the first message distribution system.

21. The method as claimed in claim 16, wherein the second message distribution system has a lower reliability and availability than the first message distribution system.

22. The method as claimed in claim 17, wherein the second message distribution system communication paths already present between peripheral appliances are used outside the first message distribution system.

23. The method as claimed in claim 17, wherein the joined signaling data has a sequence corresponding to the divided signaling data or corresponding to a function to be carried out.

24. The method as claimed in claim 17, wherein the joined signaling data has a sequence corresponding to the divided signaling data and corresponding to a function to be carried out.

25. The method as claimed in claim 17, wherein a function monitoring system operates in the peripheral appliance for the second message distribution system and faulty communication relations are established at the same time.

26. The method as claimed in claim 25, further comprising identifying an error when transmitting via the second message distribution system; and accessing the second peripheral appliance via the first message distribution system in response to identifying the error.

27. The method as claimed in claim 26, wherein for an error in the second peripheral appliance, the procedures of a switching system which are usual in such a case are started, in that the communication path to the second peripheral appliance is further monitored via the second message distribution system and in that when a redundant peripheral appliance is present, the tasks of the faulty peripheral appliance are taken over by said redundant peripheral appliance.

28. The method as claimed in claim 27, wherein for an error outside the second peripheral appliance, the error is further localized by directly accessing a device detecting the error, and the signaling data is routed as an alternative via the first message distribution system or is rejected or a relevant connection is disconnected.

29. The method as claimed in claim 27, wherein after the localization of the error the corresponding faulty component is alerted.

30. The method as claimed in claim 29, wherein the alerting of the faulty component is carried out by a central alarm device.

31. The method as claimed in claim 30, wherein the central alarm device is accommodated in one of the peripheral appliances.

32. The method as claimed in claim 17, wherein the data not relevant to the switching system is the session description protocol part of the signaling protocol H.248

33. The method as claimed in claim 17, wherein the data not relevant to the switching system is the session initiation protocol or packet data transmitted on an D-channel of an ISDN connection.

34. A device for transmitting signaling data between peripheral appliances of a switching system, which comprises a first message distribution system and a second message distribution system, comprising:
a separator that divides a first signaling data into a first part relevant to the switching system and a first part non relevant to the switching system;
a transmitter that transmits the first relevant part to the switching system via the first message distribution system and transmits the first non relevant part to the switching system via the first message distribution system or via the second message distribution system;
a receiver for receiving a second relevant part and a second non-relevant part; and
a combiner that joins the second parts to form a second signaling data.
